(19) United States
(12) Patent Application Publication
(10) Pub. No.: US 2009/0158736 A1
(43) Pub. Date: Jun. 25, 2009

(54) Thermal power plant incorporating subterranean cooling of condenser coolant

(75) Inventor: Robert Charles Mierisch, Melbourne (AU)

Correspondence Address: WEINGARTEN, SCHURGIN, GAGNEBIN & LEBOVICI LLP, TEN POST OFFICE SQUARE, BOSTON, MA, 02109, US

(73) Assignee: SOLAR HEAT AND POWER PTY LTD, Singleton, NSW (AU)

(21) Appl. No.: 12/282,936

(22) PCT Filed: Mar. 2, 2007
(86) PCT No.: PCT/AU07/00268

§ 371 Date: Jan. 22, 2009

(30) Foreign Application Priority Data
Mar. 15, 2006 (AU) 2006 901330
Mar. 15, 2006 (AU) 2006 901333
Nov. 17, 2006 (AU) 2006 906409
Jan. 31, 2007 (AU) 2007 900436

(51) Int. Cl. F01D 15/10; F24J 2/32; F24J 2/42; F03G 6/06

(52) U.S. Cl. 60/641.8; 165/45; 60/670; 60/659

(57) ABSTRACT

A thermal power plant is disclosed that comprises a heating system (10) that utilizes solar radiation for heating a working fluid, a turbine (11) to which, in operation, the working fluid is delivered, a condenser (13) located downstream from the turbine and arranged for condensing vapour exhausted from the turbine, and a cooling system (14) associated with the condenser. The heating system comprises a field of reflectors (17) that, during diurnal periods, are arranged (for example by pivoting) to reflect incident solar radiation to a receiver (18) for heating the working fluid. The cooling system (14) is arranged in operation of the power plant to transport a coolant fluid to which heat is transferred during vapour condensing and it comprises a subterranean heat exchanger incorporating conduits (27) through which the coolant is recirculated when cycling through the condenser. In one embodiment of the power plant the cooling system/subterranean heat exchanger (14) is positioned within ground that is located at least in part below the field of reflectors (17). Also disclosed is a method of operating a thermal power plant.

### FIELD OF THE INVENTION

This invention relates to a thermal power plant that utilizes solar radiation for heating a working fluid and which incorporates subterranean cooling of condenser coolant.

### BACKGROUND OF THE INVENTION

A thermal power plant typically comprises a steam producing plant, a steam turbine to which the steam is fed, a condensing plant located downstream from the turbine and a cooling system associated with the condensing plant. Also included in the power plant are such ancillary components and systems as provide for fluid reticulation, fluid storage, water/steam separation and heat recuperation, and the turbine is employed to drive an associated electrical generator. The working fluid (in its liquid phase) may comprise water alone or a water-mixture containing an additive such as ammonia. An alternative, less typical, thermal power plant employs a so-called organic Rankine cycle in which a hydrocarbon working fluid (such as pentane or a pentane-hexane mixture) is employed as a substitute for water.

The various types of known steam producing plant include fossil fuel fired steam generators, nuclear reactor powered steam generating plant and, to a lesser extent, solar energy collection/exchange systems. The types of condensing plant that are variously employed in power plants are determined in part by output power requirements and the availability (or otherwise) of a local natural heat sink such as a lake or river system. However, they typically comprise shell-and-tube condensers or direct contact condensers and they employ coolant water to which latent and sensible heat is transferred in the steam condensing process.

In the absence of sufficiently large natural (topographical) heat sinks, the variously known condensers require cooling systems for the coolant water. Thus, heat must be removed from the coolant water before it is recycled back through a condenser and the most common method of achieving this is by employment of evaporative cooling. However, evaporative (wet) cooling towers lose water to evaporation and require sources of clean top-up water for sustained operation. Also, their open construction permits pollution of the coolant water by contaminants from the atmosphere and, whilst controlled draining and chemical treatments are in practice employed to minimise the concentration of contaminants, evaporative cooling remains unsuitable for use with direct contact condensers.

Dry cooling towers are employed as alternatives to evaporative cooling towers in situations where, for example, the levels of water lost to evaporation cannot reasonably be accommodated. These towers employ forced air cooling of the coolant water, as it is recirculated in a closed circuit, but the dry cooling process is less efficient than evaporative cooling. Thus, dry cooling towers are limited in their cooling capacity by the prevailing temperature of ambient air. Also, higher condensing pressures, resulting from higher coolant temperatures under high ambient temperature conditions, cause a reduction to occur in output performance of turbines from which low pressure steam is exhausted for condensing.

U.S. Pat. No. 4,348,135 (St. Clair), dated 7 Sep. 1982 discloses a system in which, in the context of land drainage, irrigation and/or aeration, reference is made to sub-surface heat exchange between the ground and water used in air conditioning, house heating and industrial power plants. Also, U.S. Pat. No. 4,388,966 (Spiegel), dated 21 Jun. 1983 discloses an in-ground heat exchanger for use in conjunction with a power plant. The heat exchanger incorporates pipes and manifolds, with the relative dimensions of the pipes and manifolds and the shaping of the pipes being such as to minimise the effects of dilation and contraction stresses induced in the heat exchanger with temperature variations in heat exchange fluid.

### SUMMARY OF THE INVENTION

The present invention provides a thermal power plant comprising a heating system that utilizes solar radiation for heating a working fluid, a turbine to which, in operation, the working fluid is delivered, a condenser located downstream from the turbine and arranged for condensing vapour exhausted from the turbine, and a cooling system associated with the condenser. The heating system comprises a field of reflectors that, during diurnal periods, are arranged (for example to be pivoted) to reflect incident solar radiation to at least one receiver for heating the working fluid. The cooling system is arranged in operation of the power plant to transport a coolant fluid to which heat is transferred during vapour condensing and it comprises a subterranean heat exchanger through which the coolant fluid is recirculated when cycling through the condenser.

The invention may also be defined as providing a thermal power plant comprising means for heating a working fluid by use of solar energy, turbine means to which, in operation, the working fluid is delivered, means for condensing vapour exhausted from the turbine, and a cooling system associated with the condenser. The heating system comprises a field of reflectors that, during diurnal periods, are arranged (for example to be pivoted) to reflect incident solar radiation to at least one receiver for heating the working fluid, and the cooling system comprises subterranean means for dissipating heat into the ground from a coolant fluid to which heat is transferred during vapour condensing.

The invention may be still further defined as providing a method of operating a thermal power plant comprising:

utilizing solar radiation to heat a working fluid by reflecting the solar radiation with a field of reflectors to at least one receiver,
driving a turbine with the heated working fluid, and
downstream from the turbine, dissipating waste heat from the working fluid underground.

Thus, the present invention seeks to alleviate the above-mentioned problems (of cooling the condenser coolant) by introducing the novel aspect of directing the coolant fluid into the subterranean heat exchanger, whereby surrounding earth is employed to absorb heat from the coolant fluid. The absorbed heat is subsequently released to the atmosphere when a localised temperature differential occurs between the earth and adjacent atmosphere, typically when solar irradiation is reduced by cloud cover or during periods between sunset and sunrise.

### Optional Features of the Invention

The cooling system incorporating the subterranean heat exchanger may be employed as the sole cooling system for the coolant fluid, or it may be employed in conjunction with another type of cooling system such as a wet cooling system or an alternative form of dry cooling system

The working fluid may be heated by passing it through the (at least one) receiver or by exchanging heat between an intermediate fluid, that is passed through the receiver, and the working fluid.

The working fluid may optionally comprise a hydrocarbon fluid or other fluid that is suitable for expanding through a turbine, but in one embodiment of the invention it comprises water or a water mixture. When in the form of water the working fluid will normally be heated to a temperature in the range 200° C. to 400° C. (although higher and lower temperatures are feasible) but when in the form of a hydrocarbon it will have a temperature not less than 150° C.

The condenser may optionally comprise one in which the working fluid and the coolant fluid are physically separated as, for example, a shell and tube condenser or a channeled condenser in which the working fluid and coolant flow in heat exchange relationship. However, in one embodiment of the invention the condenser comprises a direct contact condenser in which the coolant fluid is contacted with the working fluid. The coolant fluid may comprise any suitable (liquid or gaseous) fluid and it may optionally comprise water with or without an additive.

The subterranean heat exchanger optionally is located within an area of ground that is positioned below the reflector field. In such case the heat exchanger may be located wholly within an area of ground that is positioned below the reflector field in order to maximise shading when the reflectors are positioned (pivotally) to reflect incident radiation to the receiver. However, in the event that the heat exchanger should be required, for heat dissipation, to be of such a size as to exceed the area of the reflector field for example, a less than complete area of the heat exchanger may be located below the reflector field. Thus, in this latter case, the heat exchanger will be located within an area of ground that is positioned at least in part below the reflector field, and the field of reflectors be used to shield from solar radiation the region of the earth in which the heat exchanger is located.

With the above described shielding arrangement the ground in which the heat exchanger is buried will be able to absorb heat from the heat exchanger in an amount at least equal to the heating effect of solar radiation that would otherwise impinge on the relevant area, without “excess” ground heating occurring. Also, the reflectors might be pivoted to a fully open condition or, if more appropriate, to a partially open louvred position between sunset and sunrise to facilitate maximum heat dissipation (by convection and radiation) from the ground below the reflectors.

The heat exchanger optionally comprises an array of conduits that extend, for example in parallel, between and interconnect spaced-apart manifolds. Also, a coolant fluid inlet to the heat exchanger is located at one end of one of the manifolds and a coolant fluid outlet is optionally located at a diagonally disposed end of the other of the manifolds.

The heat exchanger is optionally formed with an inter-conduit spacing of the order of 0.5 m and, with this structure, the heat exchanger will, depending upon system requirements, have an effective area of 25×10³ to 100×10³ m² per 10⁶ W of electrical power generation.

The conduits may be formed from any material that has a capacity to transfer heat from the coolant fluid to the surrounding earth and they optionally are formed from a polymeric material such as low density polyethylene. Also, the conduits may have an inside diameter within the range 50 to 100 mm and a wall thickness in the range 0.5 to 2.0 mm. The heat exchanger may be buried within the ground to a depth that is determined by the thermal conductivity of the surrounding earth and optionally to a depth within the range 0.25 to 1.00 m. Transversely extending weighting strips may optionally be laid over the conduits to inhibit upward floating of the heat exchanger.

The field of reflectors optionally comprises an array of parallel reflectors and each reflector desirably (but not necessarily) is pivotal about a horizontal axis.

The invention will be more fully understood from the following description of one embodiment of a thermal power plant. The description is provided by way of example and with reference to the accompanying drawings.

### BRIEF DESCRIPTION OF THE DRAWINGS

FIG. 1 shows a block-diagrammatic representation of elemental components of the thermal power plant,

FIG. 2 shows a more detailed block-diagrammatic representation of the thermal power plant.

FIG. 3 shows a schematic representation of a heating system portion of the thermal power plant, the heating system being in the form of a solar collector system and being illustrated in an operating condition,

FIG. 4 shows a perspective view of one embodiment of the heating system of FIG. 3,

FIG. 5 shows a further schematic representation of the heating system but in a non-operating condition,

FIG. 6 shows a plan view of a subterranean heat exchanger that is associated with a condenser component of the thermal power plant, and

FIG. 7 shows a schematic representation of interconnections made between the heat exchanger and the condenser.

### DETAILED DESCRIPTION OF EXEMPLARY EMBODIMENT OF THE INVENTION

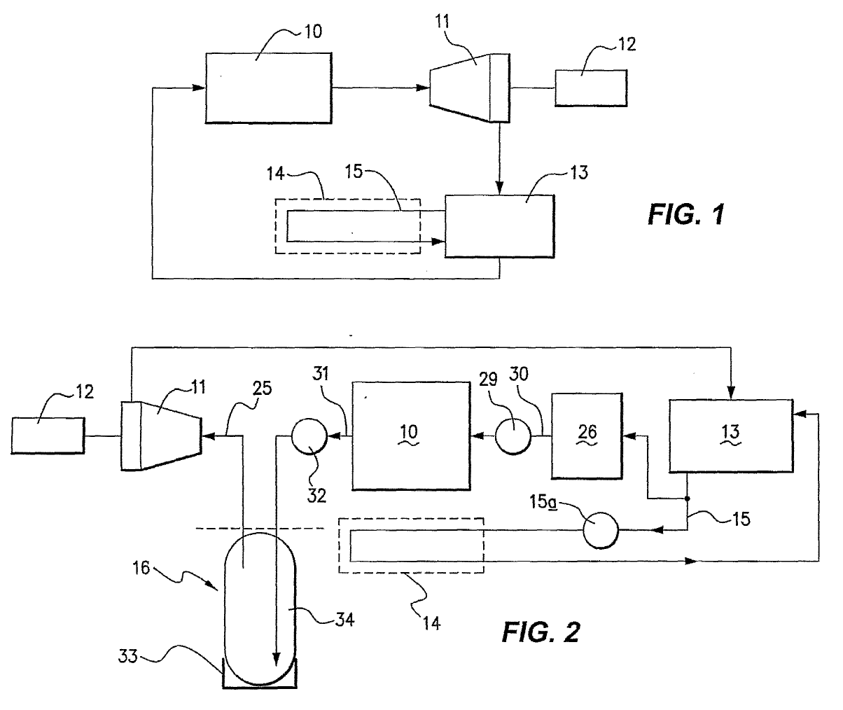

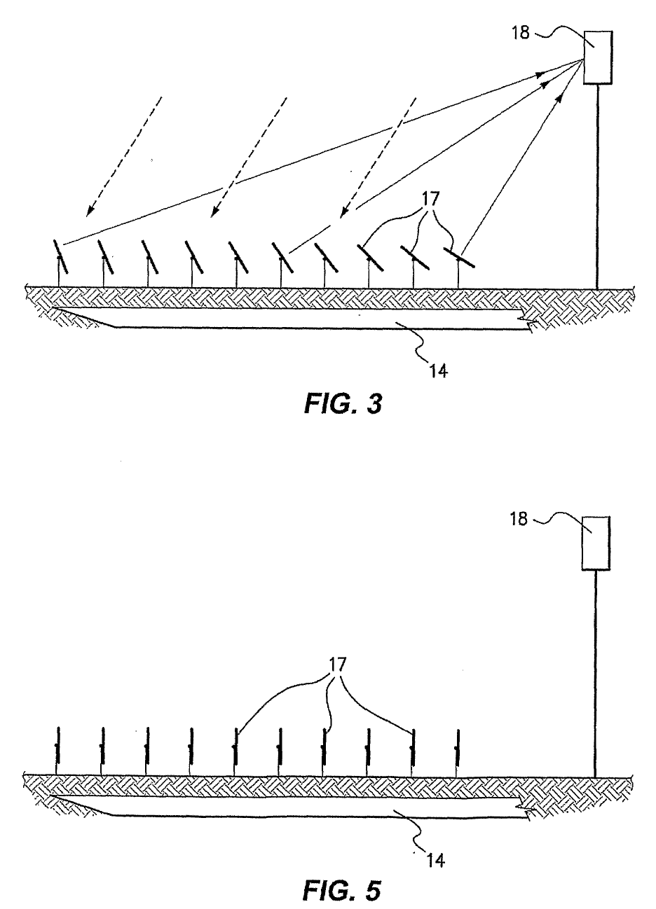

As illustrated in FIG. 1, the thermal power plant comprises a heating system 10 in which heat is transferred to a working fluid. The heating system utilizes solar energy, as hereinafter described more fully with reference to FIGS. 3 to 5.

The working fluid may comprise a hydrocarbon or such other fluid as is suitable for expanding through a turbine, but the working fluid preferably comprises water or, in its vapour/gaseous phase, steam. The working fluid when heated is delivered to a turbine 11 which is employed to drive an electrical generator 12 and, having expanded through the turbine, the working fluid is then passed to a condenser 13 where residual vapour is condensed to a liquid phase. From the condenser 13 the working fluid is returned to the heating system 10.

Both the turbine 11 and the condenser 13 are selected to meet design parameters as determined, for example, by required output power, operating temperature and operating pressure. The condenser 13 may comprise one in which the working fluid and a coolant fluid are channeled through separate circuits or, as below described with reference to FIG. 2, the condenser may comprise a direct contact condenser.

The coolant fluid for the condenser will be determined (as to its composition) by the working fluid that is employed in the system and it will normally be the same as the working fluid when the condenser comprises a direct contact condenser. The cooling system includes a heat exchanger 14 that forms a part of a cooling system loop 15 through which the coolant fluid is recirculated when cycling through the condenser. The heat exchanger 14, comprising a subterranean conduit system, is buried within the earth in the region of the thermal power plant. The earth surrounding the heat exchanger absorbs heat from the coolant fluid and the absorbed heat is subsequently released to the atmosphere when an appropriate temperature differential exists, for example after sunset.

FIG. 2 illustrates one possible implementation of the thermal power plant of FIG. 1 and like reference numerals are used to identify like components of the plant. As illustrated, the thermal power plant incorporates a heating system 10 in the form of a solar energy collector system, a steam turbine 11 coupled to an electrical generator 12, and a thermal storage system 16. Ancillary equipment, such as valves and metering devices, as would normally be included in such a plant have been omitted from the drawings as being unnecessary for an understanding of the invention. So too have been connections and valving arrangements that may be provided for by-passing the thermal storage system 16 and for feeding the steam turbine directly from the solar collection system.

The solar energy collector system 10 is illustrated in a diagrammatic way in FIGS. 3 and 5 and it comprises a field of arrayed ground-mounted, pivotal reflectors 17 that are driven to track the sun and, in so doing, to reflect incident solar radiation to illuminate an elevated receiver system 18. In the form illustrated, the reflectors 17 pivot about horizontal axes.

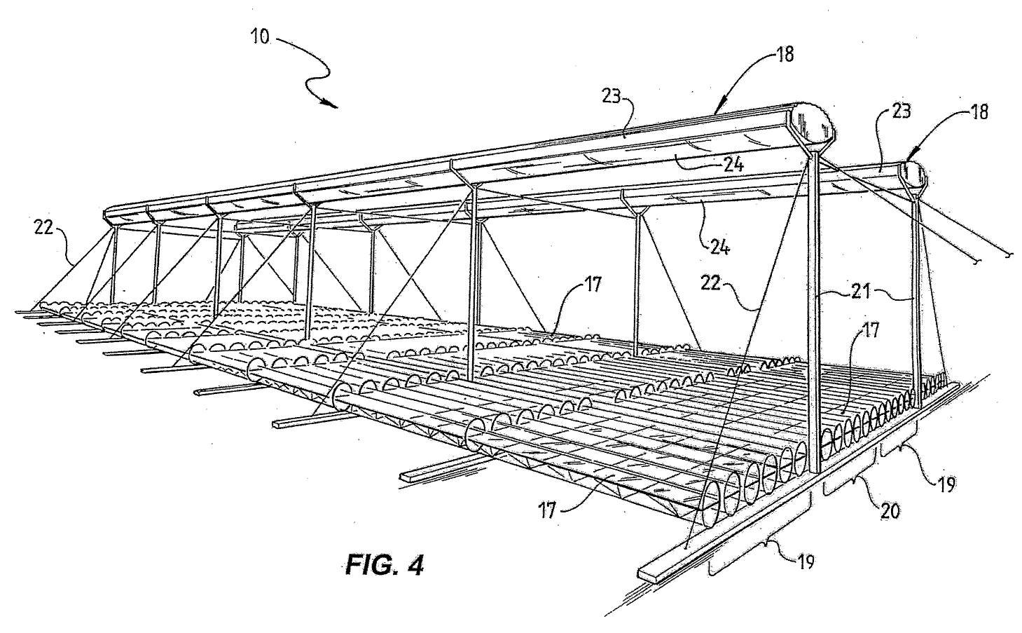

As shown in more detail in FIG. 4, the solar collector system 10 comprises two notionally separate fields 19 and 20 of ground mounted reflectors 17 that are located in parallel rows that extend generally in the north-south direction, although they may, when appropriately spaced, extend generally in an east-west direction Also, the solar collector system as illustrated in FIG. 4 comprises two parallel receivers 18. The complete solar collector system might occupy a ground area within the range 5×10² m² to 25×10⁶ m² and the system as shown in FIG. 4 may comprise a portion only of the complete solar collector system.

In the system as illustrated in FIG. 4, each receiver 18 receives reflected radiation from twelve rows of reflectors 17. Thus, each receiver 18 is illuminated by reflected radiation from six rows of reflectors 17 at one side of the receiver system and from six rows of reflectors 17 at the other side. Each row of the reflectors 17 and, hence, each receiver 18 might typically have an overall length of 300 to 600 metres, and the parallel, north-south extending receivers 18 might typically be spaced apart by 30 to 35 metres. The receivers 18 are supported at a height of approximately 11 metres by stanchions 21 which are stayed by ground-anchored guy wires 22.

Each of the receivers 18 comprises an inverted trough 23 which is closed at its underside by a longitudinally extending window 24. The window is formed from a sheet of material that is substantially transparent to solar radiation and it functions to define a closed (heat retaining) longitudinally extending cavity within the trough 23. Longitudinally extending stainless steel absorber tubes (not shown) are located in the trough 23 for carrying the working fluid.

The reflectors 17 might typically comprise units as disclosed in International Patent Applications PCT/AU2004/000883 and PCT/AU2004/000884, and the receiver systems 18 might typically comprise systems as disclosed in International Application PCT/AU2005/000208. The disclosures of the referenced Applications are incorporated herein by reference.

When, as described, the working fluid comprises water, flash steam from the upper region of the thermal storage system 16 (FIG. 2) is conveyed to the turbine 11 by a conduit 25. After expanding through the turbine the exiting vapour is directed into the condenser 13 and to a following condensate reservoir 26. The reservoir 26 accommodates fluctuations in the level of working fluid in the thermal storage system 16 and provides for balancing of transport of the working fluid throughout the plant.

As indicated previously, the condenser 13 desirably (but not necessarily) comprises a direct contact condenser in which the coolant fluid (in this embodiment water) is contacted with the working fluid for the purpose of extracting sensible and latent heat from the working fluid in the condensing process.

The subterranean cooling system/heat exchanger 14 through which the coolant fluid is passed (by way of a pump 15a) comprises a plurality of conduits 27 that are interconnected by above-ground end feeders or manifolds 28. The subterranean cooling system as illustrated is located in the ground, at a depth of approximately 0.3 m. to 0.6 m., below the field of reflectors 17 and, thus, is at least partially shaded by the reflectors whilst they are reflecting incident solar radiation. The reflectors 17 are pivoted to a fully open condition as shown in FIG. 5 or, if more appropriate, to a partially open louvred position between sunset and sunrise to facilitate maximum heat dissipation (by convection and radiation) from the ground below the reflectors.

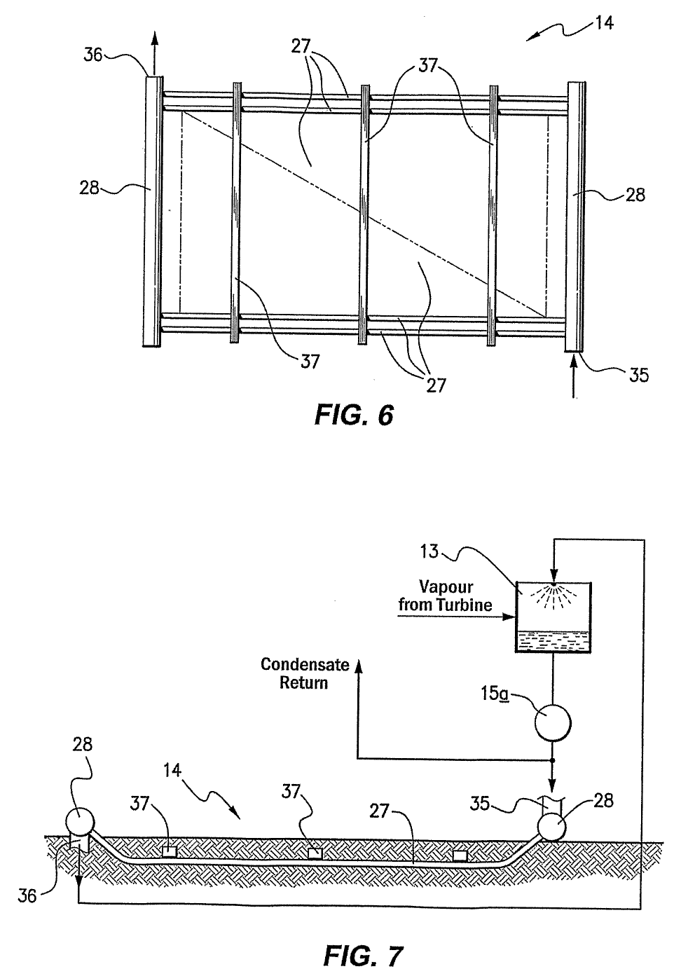

As shown diagrammatically and by way of example in FIG. 6 the conduits 27 are arranged as a parallel network of conduits that extend between and interconnect the spaced-apart manifolds 28. The coolant fluid from the condenser 13 is fed to an inlet end 35 of one of the manifolds 28 and is redirected to the condenser from the diagonally opposite end 36 of the other manifold. In the case of a plant that generates power of the order of 2.0 MW electrical, the heat exchanger might typically be constituted by approximately 400 conduits, each having a length of approximately 500 m., with an inter-conduit spacing of about 0.5 m. That is, in one embodiment of the invention a heat exchanger area of about 50×10³ m² is provided per 10⁶ W. of electrical power generation.

However, the cooling system/heat exchanger 14 may be embodied in other ways, for example using continuous or parallel loop-type reticulation systems that are arranged when buried to effect heat transfer to the earth from the reticulated coolant fluid.

In operation of the above described embodiment of the plant, the coolant water at a temperature of 42° C. is delivered to the heat exchanger 14 under pressure of 250 kPa and exits from the heat exchanger at a temperature of 39° C. under pressure of 240 kPa, to enter the condenser 13 (at an elevation of about 18 m. relative to the heat exchanger) at a pressure of about 60 kPa and a temperature of 39° C. The coolant is, in the described embodiment, delivered to the condenser 13 at a rate of 320 kg sec⁻¹ to condense steam from the turbine 11 at a temperature of about 44° C. This arrangement is shown diagrammatically in FIG. 7.

The conduits 27 may be formed from various materials but will typically be formed from low density polyethylene (LDPE) and have a 65 mm. inside diameter and a 1.0 mm wall thickness. The conduits will normally be pressurised with air during installation in the ground to permit testing for leaks, to exclude ingress of foreign material and to prevent collapsing prior to the admission of the coolant fluid. Transversely extending weighting strips 37 are located over the conduits 27 to prevent the conduits from “floating” to the surface of the earth in which they are buried.

Also in operation of the above described plant, water at a temperature of about 30° C. to 50° C., is conveyed to the solar energy collector system 10 by way of a pump 29 and conduit 30 where it is heated to a temperature in the range of 270° C. to 340° C. and returned via conduit 31 and pump 32 to the lower region of the thermal storage system 16, under a pressure of about 70 to 100 Bar.

The thermal storage system 16 may be located above or below ground but, as illustrated, comprises a vertically extending cylindrical cavity 33 which is formed within the ground. The cavity 33 has a diametral dimension that is substantially smaller than the cavity's longitudinal depth, and a cylindrical steel vessel 34 that holds the pressurised water is positioned within the cavity. The vessel 34 is formed with a relatively thin wall, having a thickness in the range 6 mm to 16 mm over a major portion of its extent, and the vessel is otherwise dimensioned to be a neat fit in the cavity 33 and thus to function as a liner for the cavity. Thus, the cavity itself effectively forms the side and bottom walls of the (pressurised) thermal storage system.

Variations and modifications may be made in respect of the power plant as above described without departing from the scope of the invention as described and defined in the following claims. For example, whereas the heating system 10 has been described in the illustrative embodiment in relation to a linear Fresnel reflector system, alternative solar systems may be employed. Thus, the heating system 10 may, for example, employ parabolic trough type reflectors for focussing incident radiation on associated (individual) receivers, or the heating system may employ a field of heliostats to reflect concentrated incident solar radiation to at least one tower-mounted receiver. In this latter case each heliostat may incorporate a fixed horizontal axis or, alternatively, a fixed vertical axis, and the tower-mounted receiver(s) may be arranged to carry the working fluid or an intermediate fluid that is contacted in heat exchange relationship with the working fluid.

1. A thermal power plant comprising a heating system that utilizes solar radiation for heating a working fluid, a turbine to which, in operation, the working fluid is delivered, a condenser located downstream from the turbine and arranged for condensing vapour exhausted from the turbine, and a cooling system associated with the condenser; wherein the heating system comprises a field of reflectors that, during diurnal periods, are arranged to reflect incident solar radiation to at least one receiver for heating the working fluid, and wherein the cooling system is arranged in operation of the power plant to transport a coolant fluid to which heat is transferred during vapour condensing and comprises a subterranean heat exchanger through which the coolant fluid is recirculated when cycling through the condenser.

2. A thermal power plant as claimed in claim 1 wherein the working fluid is heated to a temperature of at least 150° C. by directing it through the at least one receiver.

3. A thermal power plant as claimed in claim 1 wherein the working fluid comprises a liquid composed at least predominantly of water.

4. A thermal power plant as claimed in claim 1 wherein a thermal storage system is located in circuit between the heating system and the turbine.

5. A thermal power plant as claimed in claim 1 wherein the condenser comprises a direct contact condenser in which the coolant fluid is contacted with the working fluid.

6. A thermal power plant as claimed in claim 1 wherein the coolant fluid comprises water.

7. A thermal power plant as claimed in claim 1 wherein the subterranean heat exchanger is positioned within ground that is located at least in part below the field of reflectors.

8. A thermal power plant as claimed in claim 1 wherein the subterranean heat exchanger is positioned within an area of ground that is located wholly below the reflector field.

9. A thermal power plant as claimed in claim 1 wherein the subterranean heat exchanger comprises an array of conduits.

10. A thermal power plant as claimed in claim 1 wherein the subterranean heat exchanger comprises an array of parallel conduits that extend between and interconnect spaced-apart manifolds.

11. A thermal power plant as claimed in claim 10 wherein the manifolds are located at or above the surface of the ground.

12. A thermal power plant as claimed in claim 10 wherein a coolant fluid inlet to the heat exchanger is located at one end of one of the manifolds and a coolant fluid outlet is located at a diagonally disposed end of the other of the manifolds.

13. A thermal power plant as claimed in claim 10 wherein the subterranean heat exchanger is formed with an inter-conduit spacing of the order of 0.5 m and the heat exchanger has an effective area of 25×10³ to 100×10³ m² per 10⁶ W of electrical power generation.

14. A thermal power plant as claimed in claim 9 wherein the conduits are formed from a polymeric material.

15. A thermal power plant as claimed in claim 9 wherein the conduits are formed from low density polyethylene.

16. A thermal power plant as claimed in claim 15 wherein the conduits have an inside diameter within the range 50 to 100 mm and a wall thickness in the range 0.5 to 2.0 mm.

17. A thermal power plant as claimed in claim 1 wherein the subterranean heat exchanger is be buried within the ground to a depth within the range 0.25 to 1.00 m.

18. A thermal power plant as claimed in claim 9 wherein transversely extending weighting strips are positioned within the ground in overlaying relationship with the conduits to inhibit upward floating of the heat exchanger.

19. A thermal power plant as claimed in claim 1 wherein the field of reflectors comprises an array of parallel reflectors and wherein each reflector is pivotal about a horizontal axis.

20. A thermal power plant as claimed in claim 19 wherein the at least one receiver has a longitudinal length that extends parallel to the reflectors.

21. A thermal power plant comprising means for heating a working fluid by use of solar energy, turbine means to which, in operation, the working fluid is delivered, means for condensing vapour exhausted from the turbine, and a cooling system associated with the condenser; wherein the heating system comprises a field of reflectors that, during diurnal periods, are arranged to reflect incident solar radiation to at least one receiver for heating the working fluid, and wherein the cooling system comprises subterranean means for dissipating heat into the ground from a coolant fluid to which heat is transferred during vapour condensing.

22. (canceled)

23. A method of operating a thermal power plant comprising:
utilizing solar radiation to heat a working fluid by reflecting the solar radiation with a field of reflectors to at least one receiver,
driving a turbine with the heated working fluid, and
downstream from the turbine, dissipating waste heat from the working fluid underground.

24. A method as claimed in claim 23, further comprising at least partially shading, with the field of reflectors during at least a portion of daytime operation of the thermal power plant, ground in which waste heat from the working fluid is dissipated.

25. A method as claimed in claim 24, further comprising pivoting at least some of the reflectors to facilitate, during times of reduced solar radiation, heat dissipation from ground in which waste heat from the working fluid is dissipated.

26. A method as claimed in claim 24 wherein dissipating waste heat from the working fluid underground comprises:
transferring waste heat from the working fluid to a coolant fluid, and
passing at least a portion of the coolant fluid through a subterranean heat exchanger positioned within ground located at least partially beneath the field of reflectors to thereby transfer the waste heat to the ground.

27. A method as claimed in claim 26 wherein transferring heat from the working fluid to the coolant fluid comprises making direct contact between the working fluid and the coolant fluid.

28. A method as claimed in claim 23, comprising heating the working fluid by passing it through the receiver.

29. A method as claimed in claim 28 wherein the working fluid comprises a liquid at least a majority of which is water.

30. A method as claimed in claim 23, comprising:
heating an intermediate fluid by passing it through the receiver and
transferring heat from the intermediate fluid to the working fluid.

31. A method as claimed in claim 23, further comprising storing heat at a location in circuit between the receiver and the turbine.

32. A method as claimed in claim 23, wherein at least some of the reflectors are pivotable about horizontal axes to track the sun and reflect the solar radiation to the same receiver.

33. A method as claimed in claim 23, wherein each reflector is pivotable with an attached receiver about a horizontal axis to track the sun.

34. (canceled)
